(19) United States
(12) Patent Application Publication
(10) Pub. No.: US 2023/0018497 A1
(43) Pub. Date: Jan. 19, 2023

(54) LUBRICANT IMAGE TREATMENT AND ANALYSIS

(71) Applicant: SHELL OIL COMPANY, HOUSTON, TX (US)

(72) Inventors: Oluwaseyi Tope OGUNSOLA, Houston, TX (US); Chaitanya PRADHAN, Bangalore (IN); Aarthi THYAGARAJAN, Bangalore (IN); Vishal Raju AHUJA, Bangalore (IN); Nitish NAIR, Bangalore (IN)

(21) Appl. No.: 17/786,677

(22) PCT Filed: Dec. 24, 2020
(86) PCT No.: PCT/EP2020/087880

§ 371 Date: Jun. 17, 2022

(30) Foreign Application Priority Data
Jan. 3, 2020 (IN) 202041000266

(51) Int. Cl. G01B 11/06; G06T 7/00

(52) U.S. Cl. CPC G01B 11/0675; G06T 7/0004; G06T 2207/10024

(57) ABSTRACT

The present invention provides a method for the analysis of a tribofilm, said process comprising: a. obtaining an image of the tribofilm using a digital imaging device b. coding each pixel in the image according to the RGB colour of said pixel; c. assigning a tribofilm thickness to each pixel on the basis of the RGB colour of said pixel to produce a tribofilm thickness data point for each pixel; d. excluding all data points for parts of the image where the thickness of the tribofilm is zero or near-zero; and e. analysing the resultant individual tribofilm thickness data points.

### FIELD OF THE INVENTION

The present invention provides a system and a method for the analysis and assessment of lubricant tribofilms.

### BACKGROUND OF THE INVENTION

The main function of an engine oil or lubricant formulation is to form a protective film that reduces friction and wear between moving parts. It also cools the engine by transferring the heat to other parts. In order to examine these protective films on the rubbing surfaces within internal combustion engines, and assess the effectiveness of a lubricant composition, a series of laboratory bench tests are generally carried out.

Tribofilms are formed by the chemical bonding of additives in the lubricant formulation with metal engine surfaces. Stronger and thicker tribofilms offer wear protection by preventing metal-to-metal contact. Analysis of tribofilms is therefore a useful tool in the assessment of lubricant formulations. A particular area of focus is in the development of engine oil formulations that exhibit enhanced wear protection, in light of the increased drive towards thinner (lower viscosity) engine oil formulations targeted at increased fuel economy and the vulnerability they create.

The wear protection of a lubricant formulation can be investigated at the vehicle level in an engine test or in a laboratory bench test using a tribometer. Tribometers offer custom, timely, cost-effective and rapid screening options to investigate and compare lubricants for wear protection. The mini-traction machine 3D spacer layer imaging (MTM 3D-SLIM) instrument manufactured by PCS Instruments is one such tribometer that is commonly used for wear investigation. The tests carried out using an MTM 3D-SLIM instrument involve rubbing two surfaces together in the presence of a lubricant and then analysing the tribofilm image.

The MTM 3D-SLIM instrument engages two contacting surfaces (a ball and a disc) in the presence of the lubricant under different user-specified speeds, temperatures, loads and motions. The tribofilms formed are captured in situ by an integrated optical interferometry camera as the experiment progresses. The images represent surface changes during the test and are helpful for understanding and comparing the wear protection benefits of different lubricant technologies.

The steps involved in analysing a lubricant formulation using an MTM 3D-SLIM instrument are illustrated in FIGS. 1 and 2. Firstly (FIG. 1), the test ball is run against a steel disc in a lubricant bath for a predefined time. The test ball is then raised (FIG. 2) to bring it into contact with a lubricant-coated glass disc and an image is captured. Then the ball is lowered so the test can continue. These steps are repeated at defined intervals throughout the experiment.

At the end of the experiment, the tribofilm thickness can be calculated from the images using calibration software. These results can provide an assessment of how fast the protective films form and their thickness allowing benchmarking of the protection performance of premium lubricants.

An illustration of a typical MTM 3D-SLIM image is shown in FIG. 3a. Darkly shaded areas indicate thick tribofilms that may imply adequate engine surface protection; lightly shaded areas indicate low tribofilm thickness. No shading indicates a fresh or exposed metal surface without a tribofilm. The most commonly used method for tribofilm thickness analysis from MTM 3D-SLIM images focuses on a few sampling points and sampling locations, as shown in FIG. 3(b). Each circle returns a single value of tribofilm thickness and the overall thickness of the tribofilm is then characterised by the mean value and the standard deviation. However, this method can lead to misleading averages and standard deviations when the tribofilm is non-uniform. Further, the selection of the sampling locations is subjective and may be affected by human bias.

An improved and more accurate assessment of tribofilm, from images such as those produced by an MTM 3D SLIM tribometer, would be highly desirable in order to provide a more robust assessment of the anti-wear characteristics of a lubricant formulation.

### BRIEF DESCRIPTION OF THE DRAWINGS

FIG. 1 illustrates the first step involved in analysing a lubricant formulation using an MTM 3D-SLIM instrument.

FIG. 2 illustrated the second step involved in analysing a lubricant formulation using an MTM 3D-SLIM instrument.

FIG. 3(a) is an illustration of a typical tribofilm image produced using an MTM 3D-SLIM instrument.

FIG. 3(b) is an illustration of a commonly used method for assessing the tribofilm in the image of FIG. 3(a).

FIG. 4 is an illustration of the steps of processing a raw digital image of a tribofilm.

FIG. 5 is an illustration of a fully processed tribofilm image.

FIG. 6 is a graph illustrating the data that has been extracted from a fully processed tribofilm image.

### SUMMARY OF THE INVENTION

The present invention provides a method for the analysis of a tribofilm, said process comprising:
a. obtaining an image of the tribofilm using a digital imaging device;
b. encoding each pixel in the image according to the RGB colour of said pixel;
c. assigning a tribofilm thickness to each pixel on the basis of the RGB colour of said pixel to produce a tribofilm thickness data point for each pixel;
d. excluding all data points for parts of the image where the thickness of the tribofilm is zero or near-zero; and
e. analysing the resultant individual tribofilm thickness data points.

The present invention also provides a method for the analysis of a tribofilm, said process comprising:
a. receiving an image of the tribofilm taken using a digital imaging device;
b. encoding each pixel in the image according to the RGB colour of said pixel;
c. assigning a tribofilm thickness to each pixel on the basis of the RGB colour of said pixel to produce a tribofilm thickness data point for each pixel;
d. excluding all data points for parts of the image where the thickness of the tribofilm is zero or near-zero;
e. analysing the resultant individual tribofilm thickness data points; and
f. sending the analysis of the resultant individual tribofilm thickness data points to a user.

The present invention also provides a system for analysing a tribofilm, said system comprising:
a. a digital image acquiring device;
b. a data processing unit which codes each pixel in an image acquired by said image acquiring device according to the RGB colour of said pixel and then assigns a tribofilm thickness to each pixel on the basis of the RGB colour of said pixel; and
c. an output device which provides a tribofilm thickness data point for each pixel.

### DETAILED DESCRIPTION OF THE INVENTION

In order to overcome the limitations of traditional thickness analysis and to derive maximum value from analysis of tribofilm images, the present inventors have developed a process in which an accurate and complete assessment of a tribofilm's thickness and coverage may be carried out.

In the process of the present invention, an image of a tribofilm is obtained. There is no limitation on how the tribofilm may be produced, but in a preferred embodiment, the tribofilm is produced and an image of it is obtained in an MTM 3D-SLIM tribometer instrument.

In said instrument, two surfaces (a ball and a disc) are contacted, in the presence of the lubricant, under different user-specified speeds, temperatures, loads and motions. The tribofilms formed are preferably captured in situ by an integrated optical interferometry camera as the experiment progresses. More preferably, a series of images may be captured over time as the experiment progresses.

The images are then coded using a MATLAB software algorithm capable of splitting the colours in the image into their RGB (Red Green Blue) components at the pixel level. This assigns an RGB colour value to each pixel within the image. Such an assignment of RGB colour value may be carried out using standard MATLAB software.

Each pixel is then assigned a tribofilm thickness value on the basis of the RGB colour of said pixel. In typical optical interferometry images of tribofilms, regions lacking a tribofilm are seen as blue and regions with a tribofilm are present in varying shades of brown. Thus, as the film thickness increases, there is a transition from blues to light browns and eventually darker shades of brown. Using known correlations, the RGB data points can, therefore, be converted to tribofilm thickness data points. Such correlations are readily available, for example those already used in an MTM 3D-SLIM instrument may be used. In a preferred embodiment of the invention, an algorithm is applied to the original data points in order to carry out this conversion.

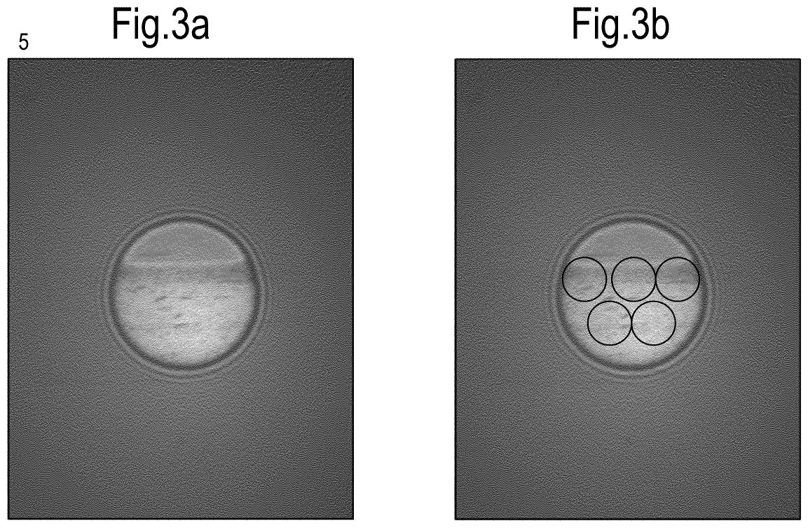

Most tribofilm images suitable for analysis by this method contain an irrelevant background (see for example, FIG. 3a. In this image, it is clearly shown that there is a circular region of interest within the original image. This circular region may be selected by a circular Hough transform. A circular Hough transform is an open source image processing algorithm used to identify objects that are circular in shape. Within the circular region of interest, only a portion of the circle is filled with tribofilm and some background is still present. In order to prevent this background from affecting the analysis, all data points for parts of the image where the thickness of the tribofilm is zero or near-zero are excluded from analysis.

The remaining data points may then be analysed using one or more methods.

In its most basic form, the data points form an equivalent thickness map that may be plotted as a 2D contour map or a 3D surface plot. The thickness map may be used to generate statistical measurements, such as the dominant film thickness, that can be used to generate insights about lubricant and additive performance. Also, for example the minimum thickness and maximum thickness and their locations may be identified and this can be used to determine whether the tribofilm is thick enough to offer the desired protection.

One desirable lubricant quality is the formation of a tribofilm with uniform thickness across the coverage area. In a standard tribofilm image, a uniform film is seen as a single shade of brown with little or no variation. A non-uniform film has multiple shades of brown that appear as bands across the tribofilm.

In a preferred embodiment of the present invention, an algorithm is applied in order to split the image into its constituent bands. This algorithm groups data points with similar thickness values within the image based on the band colour intensity. The process then provides measures such as the number of bands, the band width and the intra- and inter-band thickness variations. A normalised uniformity index can then be produced on the basis of these measures. An ideal image would have one band spanning the entire tribofilm with little variation and a metric of unity. Any deviation from this ideal scenario is penalised, so real images end up with metric values of between zero and one.

To calculate this uniformity metric, one of the following equations may be applied:

$${U}_{M} = 4 \sqrt{\frac{1}{{N}_{C}} \cdot \frac{{w}_{b}}{D} \cdot \frac{2}{{σ}_{intra}} \cdot \frac{2}{{σ}_{inter}}} \\ {U}_{A} = \frac{1}{4} [ \frac{1}{{N}_{C}} + \frac{{w}_{b}}{D} + \frac{2}{{σ}_{intra}} + \frac{2}{{σ}_{inter}} ]$$

In these equations, U_{M} is the multiplicative uniformity metric, U_{A} is the additive uniformity metric; w_{b} is inter-band spacing; D is the diameter of image; N_{C} is the number of bands; σᵢₙₜᵣₐ is the intra band std. deviation; and σᵢₙₜₑᵣ is the inter-band std. deviation. Such measurements would be readily carried out by the skilled person with a background in image processing and a knowledge of basic statistics.

An important feature of the present invention is that it enables comparison of multiple lubricant formulations based on the tribofilm thickness distribution, statistical measure and uniformity index. A pixel-by-pixel comparison of two tribofilm images can be made to compare thickness distributions.

An MTM 3D-SLIM experiment may be used to capture images at regular intervals to study the time evolution of the tribofilm during the experiment. The method of the present invention may therefore be run at each individual timestep to generate an understanding of how the thickness of the tribofilm maps and its metrics (e.g. maximum thickness, minimum thickness, dominant thickness, uniformity metric) vary as the experiment progresses. This data may be collated as a video depicting the evolution of the tribofilm along with the statistical measures and uniformity metrics.

Although the method of the present invention may be carried out by a single user, steps involving data processing may also be carried out in a data processing unit which is part of a distributed system, such as a cloud-based computing system. In this embodiment, the method of the invention involves the steps of:
a. receiving an image of the tribofilm taken by a user using a digital imaging device;
b. encoding each pixel in the image according to the RGB colour of said pixel;
c. assigning a tribofilm thickness to each pixel on the basis of the RGB colour of said pixel to produce a tribofilm thickness data point for each pixel;
d. excluding all data points for parts of the image where the thickness of the tribofilm is zero or near-zero;
e. analysing the resultant individual tribofilm thickness data points; and
f. sending the analysis of the resultant individual tribofilm thickness data points to the user.

### DETAILED DESCRIPTION OF THE DRAWINGS

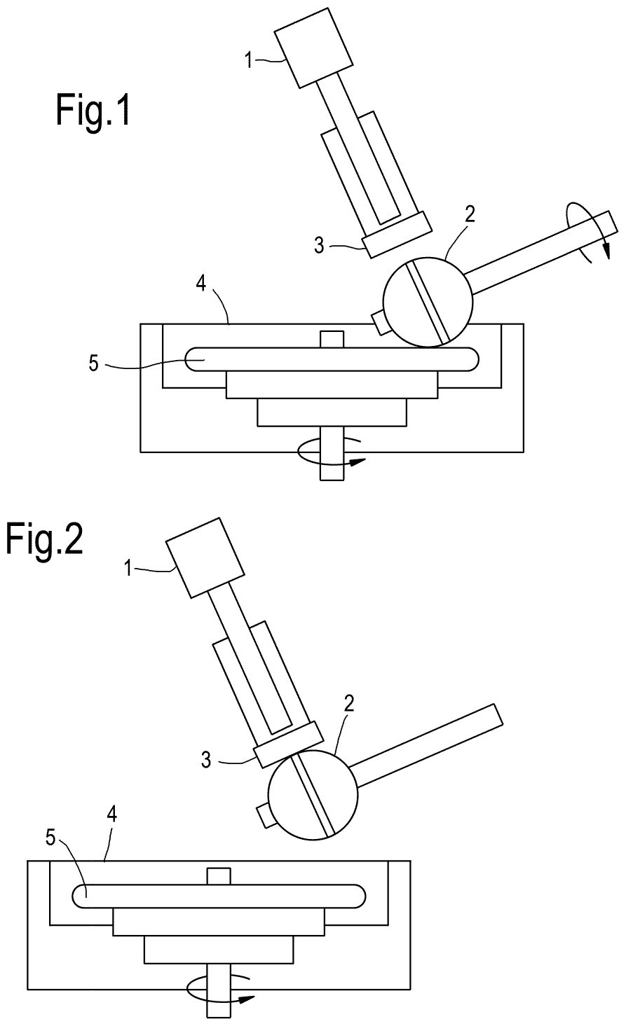

FIGS. 1 and 2 illustrate the steps involved in analysing a lubricant formulation using an MTM 3D-SLIM instrument. Firstly (FIG. 1), the test ball (2) is run against a steel disc (5) in a lubricant bath (4) for a predefined time. The test ball is then raised (FIG. 2) to bring it into contact with a lubricant-coated glass disc (3) and an image is captured using a digital imaging device (1). Then the ball is lowered so the test can continue.

FIG. 3a is an example of the image taken by the digital imaging device (1). FIG. 3b shows a typical sampling process.

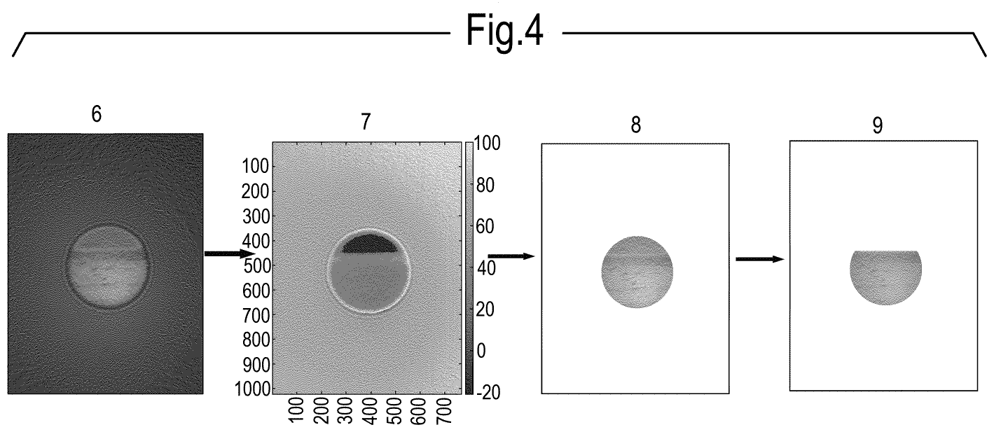

The steps involving the analysis of a tribofilm according to the present invention are shown in FIG. 4. An image (6) of the tribofilm taken using a digital imaging device (1) is analysed and each pixel is coded according to the colour of each pixel. A tribofilm thickness is assigned to each pixel on the basis of the RGB colour of said pixel to produce a tribofilm thickness data point (7) for each pixel.

Selection of the circular image (8) from the original data set then allows for all data points for parts of the image where the thickness of the tribofilm is zero or near-zero to be excluded and a map of the thickness of the tribofilm (9) pixel by pixel to be produced.

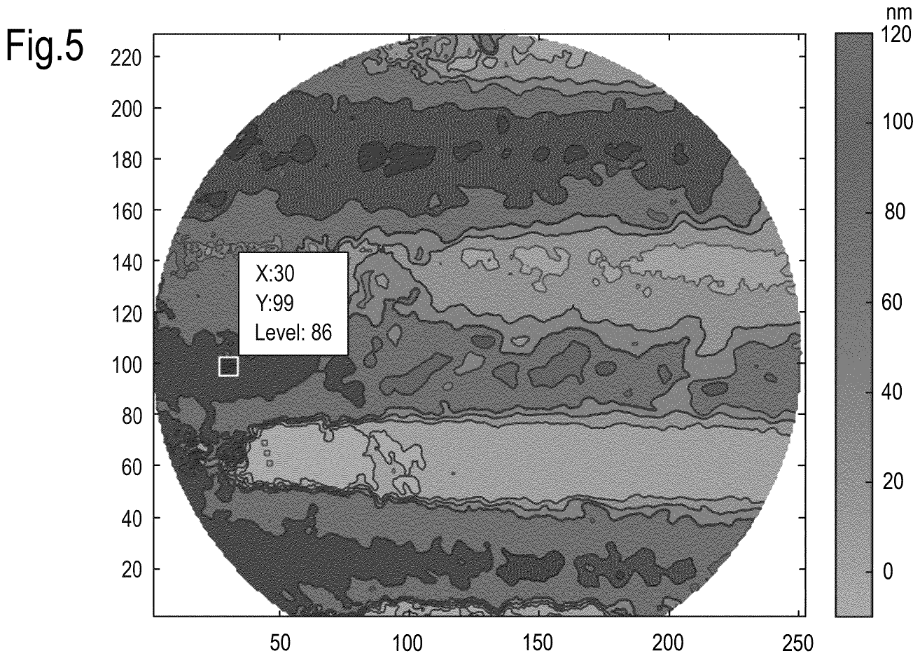

An enlarged version of such a map (9) is shown in FIG. 5. In this Figure, it is clearly shown that the thickness on a pixel by pixel basis can be identified.

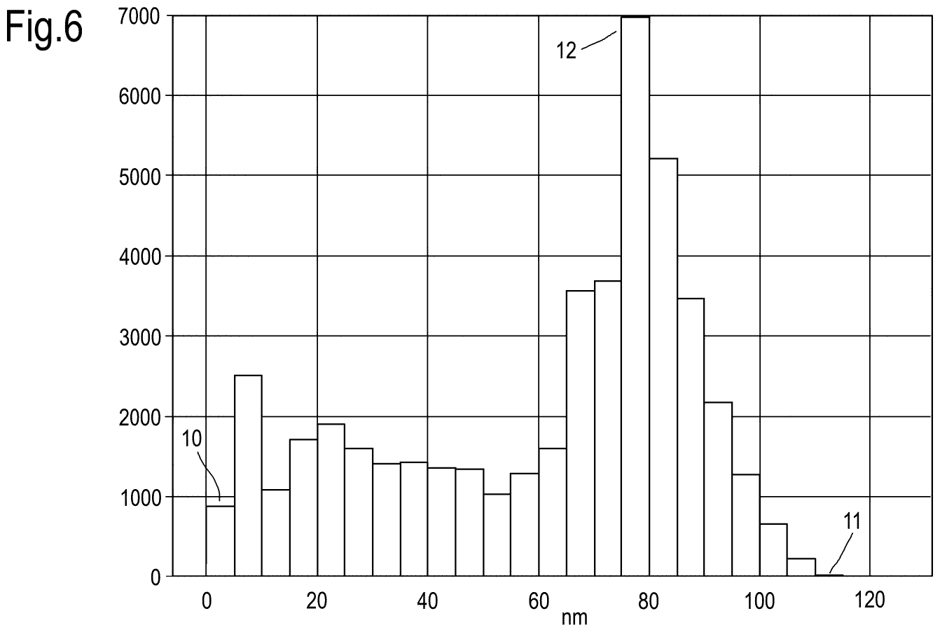

FIG. 6 shows the data extracted from the map of the thickness of the tribofilm (8) and plotted on a graph. On this graph the minimum thickness (10), maximum thickness (11) and dominant thickness (12) can clearly be seen. The spread of thickness can also be determined and compared with other samples.

We claim:

1. A method for the analysis of a tribofilm, said process comprising:
a. obtaining an image of the tribofilm using a digital imaging device
b. coding each pixel in the image according to the RGB colour of said pixel;
c. assigning a tribofilm thickness to each pixel on the basis of the RGB colour of said pixel to produce a tribofilm thickness data point for each pixel;
d. excluding all data points for parts of the image where the thickness of the tribofilm is zero or near-zero; and
e. analysing the resultant individual tribofilm thickness data points.

2. A method for the analysis of a tribofilm, said process comprising:
a. receiving an image of the tribofilm taken using a digital imaging device;
b. encoding each pixel in the image according to the RGB colour of said pixel;
c. assigning a tribofilm thickness to each pixel on the basis of the RGB colour of said pixel to produce a tribofilm thickness data point for each pixel;
d. excluding all data points for parts of the image where the thickness of the tribofilm is zero or near-zero;
e. analysing the resultant individual tribofilm thickness data points; and
f. sending the analysis of the resultant individual tribofilm thickness data points to a user.

3. A method as claimed in claim 1, wherein the tribofilm is produced and the image of it is obtained in an MTM 3D-SLIM tribometer instrument.

4. A method as claimed in claim 1, wherein the resultant individual tribofilm thickness data points are plotted on a graph and one or more of minimum thickness, maximum thickness and dominant thickness of the tribofilm are determined.

5. A method as claimed in claim 1, wherein after step e, regions in the image with similar values of thicknesses are identified and grouped into thickness bands; then a normalized uniformity index, U_{M}, between 0 and 1 is assigned to the image, on the basis of the Tribofilm thickness distribution, inter-band thickness variation, and intra-band thickness variation according to the following calculation:
$${U}_{M} = 4 \sqrt{\frac{1}{{N}_{C}} \cdot \frac{{w}_{b}}{D} \cdot \frac{2}{{σ}_{intra}} \cdot \frac{2}{{σ}_{inter}}}$$
wherein w_{b} is inter-band spacing; D is the diameter of image; N_{C} is the number of bands; σᵢₙₜᵣₐ is the intra band std. deviation; and σᵢₙₜₑᵣ is the inter-band std. deviation.

6. A method as claimed in claim 1, wherein after step e, regions in the image with similar values of thicknesses are identified and grouped into thickness bands; then a normalized uniformity index, U_{M}, between 0 and 1 is assigned to the image, on the basis of the Tribofilm thickness distribution, inter-band thickness variation, and intra-band thickness variation according to the following calculation:
$${U}_{A} = \frac{1}{4} [ \frac{1}{{N}_{C}} + \frac{{w}_{b}}{D} + \frac{2}{{σ}_{intra}} + \frac{2}{{σ}_{inter}} ]$$
wherein w_{b} is inter-band spacing; D is the diameter of image; N_{C} is the number of bands; σᵢₙₜᵣₐ is the intra band std. deviation; and σᵢₙₜₑᵣ is the inter-band std. deviation.

7. A method as claimed in claim 1 wherein the steps are repeated after pre-set time intervals as the tribofilm builds up.

8. A system for analysing a tribofilm, said system comprising:
a. a digital image acquiring device;
b. a data processing unit which codes each pixel in an image acquired by said image acquiring device according to the RGB colour of said pixel and then assigns a tribofilm thickness to each pixel on the basis of the RGB colour of said pixel; and
c. an output device which provides a tribofilm thickness data point for each pixel.

9. A system as claimed in claim 8, wherein the data processing unit is part of a distributed system, such as a cloud-based computing system.
